(19) United States
(12) Patent Application Publication
(10) Pub. No.: US 2013/0201027 A1
(43) Pub. Date: Aug. 8, 2013

(54) Apparatus and Method for Detecting Faults in a Solar Module

(71) Applicant: Charles E. Bucher, Venetia, PA (US)

(72) Inventor: Charles E. Bucher, Venetia, PA (US)

(21) Appl. No.: 13/366,007

(22) Filed: Feb. 3, 2012

(51) Int. Cl. G08B 21/18; H02H 3/24

(52) U.S. Cl. 340/660; 361/92

(57) ABSTRACT

A low cost method and apparatus for detecting faults in a solar module comprising the steps of monitoring the voltage across each string of cells within the module's junction box and signaling an alarm at the module and or at a remote location if any of the voltages across the strings of cells drop below an acceptable voltage threshold, thereby indicating a fault condition.

### BACKGROUND OF THE INVENTION

1. Field of the Invention

This invention relates to an apparatus and method for measuring the performance of a solar cell module and more particularly to a low cost apparatus and method for detecting faults in a solar cell module and signaling such fault condition.

2. Description of the Background Art

Photovoltaic (PV) devices for producing electrical energy directly from sunlight have become increasingly popular in recent years. Worldwide production of PV cells in 2010 exceeded 17,500 MW, with power output determined under standard test conditions (1 kW/m² light intensity, Air Mass 1.5 Global spectrum, and cell at 25 degree C.). With these solar cells typically encased in a module having a selling price of approximately $1.5/W, the 17,500 MW production represents a $26.25 billion a year industry. Furthermore, the worldwide industry output, measured in MW/year, has had a compounded annual growth rate in excess of 30%.

Presently there exist methods for detecting the failure in a solar module by measuring the voltage output of the solar module, preferably under load conditions. If the voltage output of the module is significantly lower than the standard operating voltage, a failure of an individual string is likely. Unfortunately, measuring the voltage output is very labor intensive and requires disconnecting the module from the others to make the measurement.

As set forth in JP Patent Application No 8-97456, the disclosure of which is hereby incorporated by reference herein, another method for detecting the failure in a solar module comprises inspecting the light emitting state of a light-emitting bypass diode within the module. However, disadvantages of this prior art include (1) LEDs result in a significant loss of power because of their high voltage drop over conventional diodes, (2) economical LEDs cannot carry the current required for conventional modules and (3) LEDs are very difficult to see in the sunlight thereby requiring an inspector to visually inspect each and every module from a fairly close distance. Moreover, in order to see the LEDs on the front of the module, a significant design change would have to be made to the module to allow the LEDs to be visible between the cells on the front side or on the side between the interconnect ribbons. While an easier way to mount the LEDs would be within the junction box on the back, they would be hidden on the backside and not visible from the front, thereby requiring the inspector to look under each module.

Still other methods for detecting the failure in a solar module comprise (1) measuring the temperature of the bypass diode and signal a fault if the temperature rises above a predetermined threshold and (2) providing a means for changing color by a current flowing in a bypass diode of the solar module and indicating the fault condition. The problem with these two methods is setting the threshold—temperature near the bypass diode in a module can reach temperatures greater than 80 degrees C. in standard conditions and, moreover, may vary greatly between summer and winter conditions.

Therefore, it is an object of this invention to provide an improvement which overcomes the aforementioned inadequacies of the prior art methods for detecting the fault of a solar module and provides an improvement which is a significant contribution to the advancement of detecting faults within a solar module.

Another object of this invention is to provide a fault detector for a solar module having a plurality of strings of photovoltaic cells including a microcontroller whose inputs comprise analog-to-digital converters, a plurality of bypass diodes whose cathodes and anodes are connected in parallel across the respective strings of photovoltaic cells, the cathodes of respective bypass diodes being connected to the inputs of said microcontroller; and an alarm connected to an output of said microcontroller.

Another object of this invention is to provide a fault detector for a solar module, wherein the fault detector is located in a junction box of the solar module.

Another object of this invention is to provide a fault detector for a solar module, wherein the alarm comprises an audible alarm such as a buzzer or loud speaker or a visual alarm.

Another object of this invention is to provide a fault detector for a solar module, wherein the alarm comprises a radio frequency (RF) transmitter or DC power line communication interface that sends fault detection information to a remote computer base station for data acquisition and alarm.

Another object of this invention is to provide a fault detector for a solar module, wherein the alarm indicates the specific string of photovoltaic cells whose voltage falls below a predefined minimum voltage.

Another object of this invention is to provide a fault detector for a solar module, wherein the voltages of the strings of photovoltaic cells are indicated.

Another object of this invention is to provide a fault detector for a solar module which measures the electrical current flowing between each string of photovoltaic cells.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

For the purpose of summarizing this invention, this invention comprises an apparatus and method for monitoring the voltage across each string of cells of a solar module and signaling an alarm at the module's junction box and or at a remote location if any of the voltages across the string of cells drop below an acceptable voltage threshold, thereby indicating a fault condition.

More particularly, in each embodiment, the invention comprises a bypass diode connected across a string of photovoltaic cells (e.g., 20 cells to a string). It is noted that bypass diodes are commonly employed to isolate each string of photovoltaic cells to which it is connected in the event one or more cells in such string becomes defective or shaded (i.e., no longer producing any significant power and presenting a high resistance in the string, thereby blocking the flow of power).

In the various embodiments of the invention, the cathodes of the bypass diodes are each connected to an analog-to-digital converter (ADC) to convert the analog outputs of the bypass diode to a digital signal. The outputs of the ADCs are then connected to a microprocessor for detecting the voltage level at the cathodes of the bypass diodes. The microprocessor detects when the voltage has dropped appreciably, indicative of one or more of the strings having one or more failed or shaded photovoltaic cells. It is noted that the bypass diodes are optional inasmuch as the microprocessor would be still be able to detect the output voltages of the strings.

In a first embodiment, the microprocessor outputs a signal to an audible piezoelectric buzzer in a pattern that is indicative of the number of the defective string (e.g., three buzzes if the third string of the solar module has become defective). In a second embodiment, the microprocessor outputs a signal to a loudspeaker for vocalizing the number of the defective string (e.g., vocalize through the loudspeaker “string 3 has become defective”). In a third embodiment, the microprocessor outputs a signal to a radio frequency transmitter, which is then in turn received by a computer monitoring system of a base station for alarm reporting (and to be shared via a website connected to the world wide web). The ADCs and microprocessor may comprise a single chip microcontroller (e.g., PIC® Microcontroller).

A fourth embodiment of the invention comprises measuring the current flowing between each solar module by means of a shunt resistor of the microprocessor whose voltage is measured and supplied to a computer base station.

A fifth embodiment of the invention utilizes an optocoupler whose photodiode is connected in parallel across the bypass diode to drive a phototransistor, the output of which is connected through a blocking diode to a transistor switch driving an audible piezoelectric buzzer. Unlike the first embodiment that indicates the defective string, this highly cost-effective fifth embodiment sounds the buzzer when there are one or more defective strings.

A sixth embodiment of the invention comprises a DC power line communication interface circuit that communicates the fault information along the DC wiring to a computer monitoring system optionally including an internet connection for remote monitoring. In a seventh embodiment, the DC power line communication interface includes means for monitoring the electrical current flowing between adjacent solar modules.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a schematic diagram of the first embodiment of the invention;

FIG. 2 is a flowchart of the microprocessor firmware thereof;

FIG. 3 is a schematic diagram of the second embodiment of the invention;

FIG. 4 is a flowchart of the microprocessor firmware thereof;

FIG. 5 is a schematic diagram of the third embodiment of the invention;

FIG. 6 is a flowchart of the microprocessor firmware thereof;

FIG. 7 is a schematic diagram of the fourth embodiment of the invention;

FIG. 8 is a flowchart of the microprocessor firmware thereof;

FIG. 9 is a schematic diagram of the fifth embodiment of the invention;

FIG. 10 is an elevational view of a standard junction box of a solar panel showing the manner in which the invention implemented via a printed circuit board may be easily connected in parallel to the existing wiring thereof;

FIG. 11 is a schematic diagram of the sixth embodiment of the invention;

FIG. 12 is a schematic diagram of the seventh embodiment of the invention;

Similar reference characters refer to similar parts throughout the several views of the drawings.

### DETAILED DESCRIPTION OF THE PREFERRED EMBODIMENT

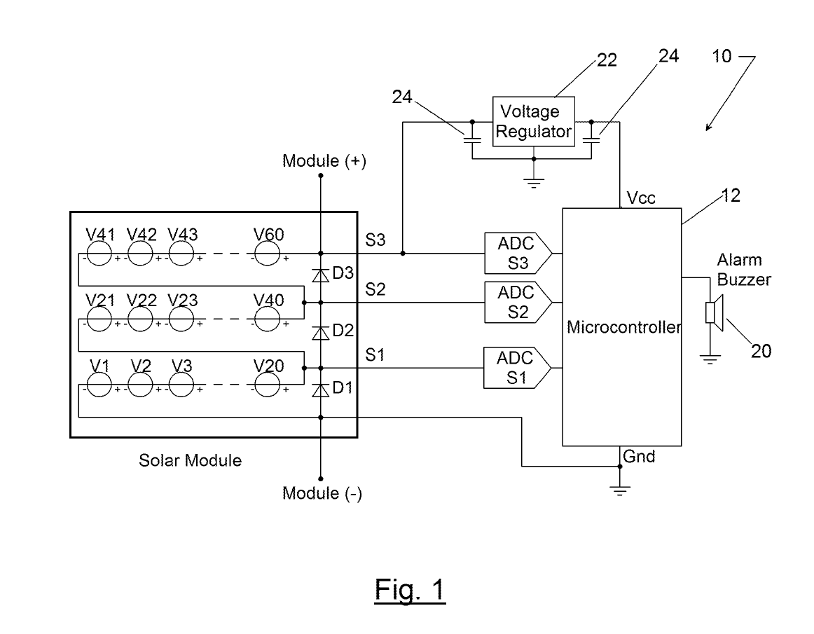

Referring to FIG. 1, the first embodiment of the invention comprises a fault detector 10 including a microcontroller 12 whose inputs comprise analog-to-digital converters ADC₁₋ₙ (internally contained within the microcontroller 12 or separately provided) connected to the cathodes of respective bypass diodes D₁₋ₙ connected in parallel across respective strings 5₁₋ₙ of photovoltaic cells V₁₋ₙ. The output of the microcontroller 12 is connected to drive an alarm such as an alarm buzzer 20. Power to the microcontroller 12 may be provided from one of the strings 5₁₋ₙ by means of a voltage regulator 22 and filter capacitors 24.

By way of background, when a photovoltaic cell is defective or shaded, it will not produce as much electrical current. The output current of the cell declines proportionally to the amount of shading. Since the cells are connected in series, shading a single cell can cause the output of the entire string of cells to fall to the same level as the shaded cell, thereby greatly reducing the power of the entire system. Because of this, bypass diodes may be used in to allow the current from the other strings to flow around the defective/shaded string and through the bypass diode.

Bypass diodes, typically located in the junction box of the solar module, are connected in parallel, but with the opposite polarity to a string of solar cell. Under normal operation, each string of solar cells will be forward biased with the diode being reverse biased. However, if a cell becomes defective or shaded, the current through the string of cells will drop and may cause the defective/shaded solar cell to reverse bias due to the mismatch in short circuit current of the other series connected cells. This will cause the bypass diode to conduct and allow the current from the good cells to flow through the diode thus allowing current to pass around the string of defective/shaded cells. The bypass diode holds the string of defective/shaded cells to a voltage of approximately −0.6 volts (i.e., the forward bias voltage of the diode), thus limiting the reduction in the output.

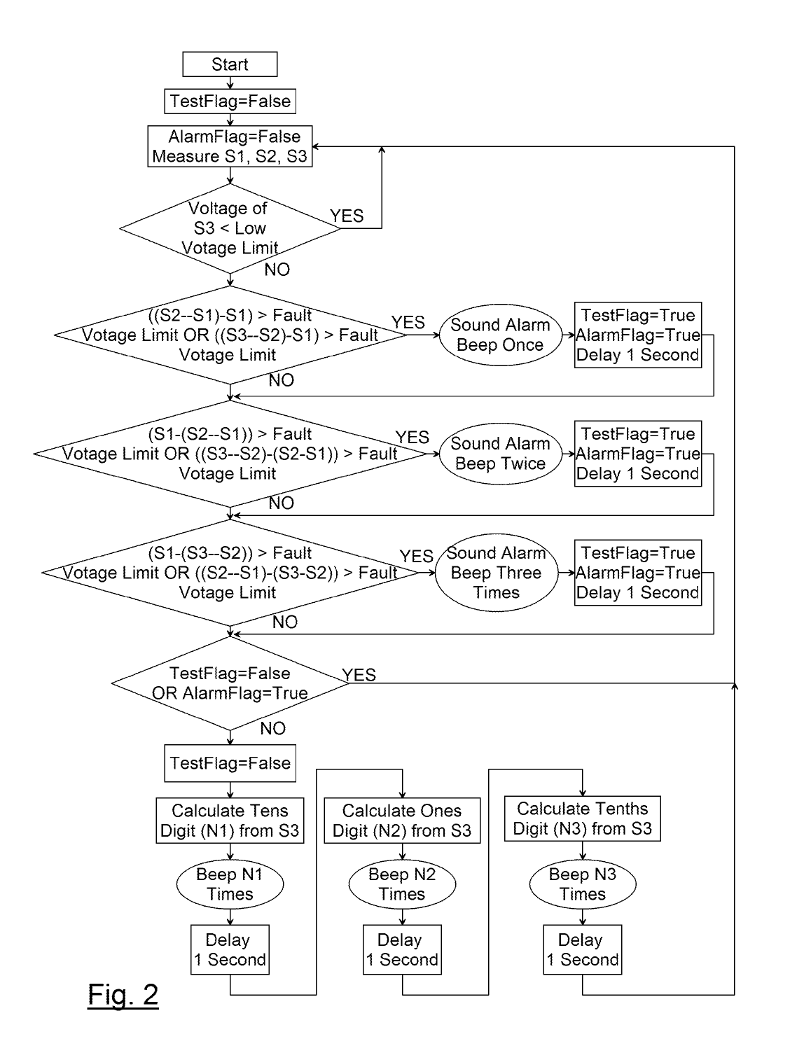

The firmware employed in the microcontroller 12 of FIG. 1 is illustrated in the flow chart of FIG. 2. At the Start of the program, TestFlag and AlarmFlag are set to False. The voltages at strings 5₁₋ₙ are each measured. The voltage of S₃ is checked and if less than a Low Voltage Limit (e.g., 18 vdc for a 60 cell module), the program simply returns. This Low Voltage Limit prevents the module from emitting nuisance alarms at start-up in the morning and shut-down at night. However, if the voltage of S₃ is not less than the Low Voltage Limit, the program proceeds to determine which of the strings 5₁₋ₙ of photovoltaic cells V₁₋ₙ is defective or shaded.

More particularly, if the voltage of ((S₂−S₁)−S₁) is greater than a Fault Voltage Limit (e.g., 5 vdc for a 20 cell string) or if the voltage of ((S₃−S₂)−S₁) is greater than the Fault Voltage Limit, the program outputs to the alarm buzzer 20 to beep once, indicating the first string S₁ of cells V₁-V₂₀ contains a defective cell or is otherwise shaded. The Test Flag and the Alarm Flag are then set true and after a delay of one second, the program continues.

Upon continuing, if the voltage of (S₁-(S₂−S₁)) is greater than a Fault Voltage Limit or if the voltage of (S₃−S₂)−(S₂−S₁) is greater than a Fault Voltage Limit, the microcontroller 12 outputs to the alarm buzzer 20 to beep twice, indicative of a defective cell V₂₁-V₄₀ in the second string S₂. The TestFlag and the AlarmFlag are then set to true and after delay the program continues. If neither of the voltages (S₁−(S₂−S ₁)) or ((S₃−S₂)−(S₂−S₁)) is not greater than the Fault Voltage Limit as described above, the program simply continues.

Upon continuing, if the voltage of (S₁31 (5₃−S₁)) is greater than a Fault Voltage Limit or if the voltage of (S₂−S₁)−(S₃−S₂) is greater than a Fault Voltage Limit, the microcontroller 12 sounds the alarm buzzer 12 three times indicative of the third string S₃ containing a defective cell V₄₁-V₆₀. The TestFlag and the AlarmFlag are then set to true and after a delay, the program continues. If neither of the voltages (S₁−(S₃−S₁)) or ((S₂−S₁)−(S₃−S₂)) is not greater than the Fault Voltage Limit as described above, the program simply continues.

It is noted that forgoing is repeated n times to coincide with the n number of strings Sₙ of photovoltaic cells V₁₋ₙ.

The program continues by checking the status of the TestFlag and the AlarmFlag and if either the TestFlag is False or the AlarmFlag is True, the program simply returns. However, if neither the TestFlag is False nor the AlarmFlag is True, the program proceeds by setting the TestFlag False and then audibly indicating the numerical value of the voltage at S₃ by calculating the Tenths Digit (N₁) and beeping N₁ times, then calculating the Ones Digit (N₂) from S₁ and beeping N₂ times and then calculating the Tenths Digit (N₃) from S₃ and beeping N₃ times. This is useful for determining the voltage of a good module. A fault condition may be simulated by intentionally shading a cell to determine the system is working properly. Upon removal of the simulated fault condition, the TestFlag will be true thereby indicating the numerical value of the voltage.

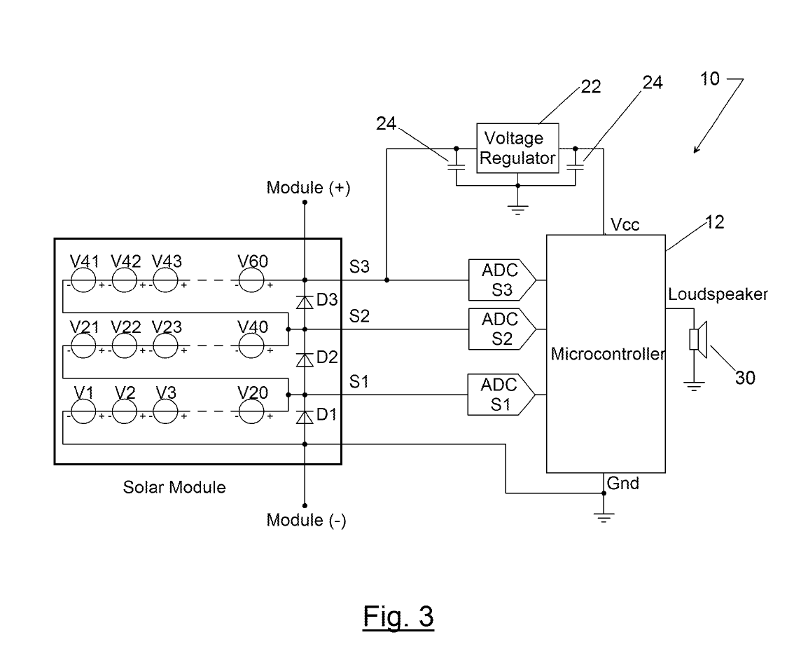

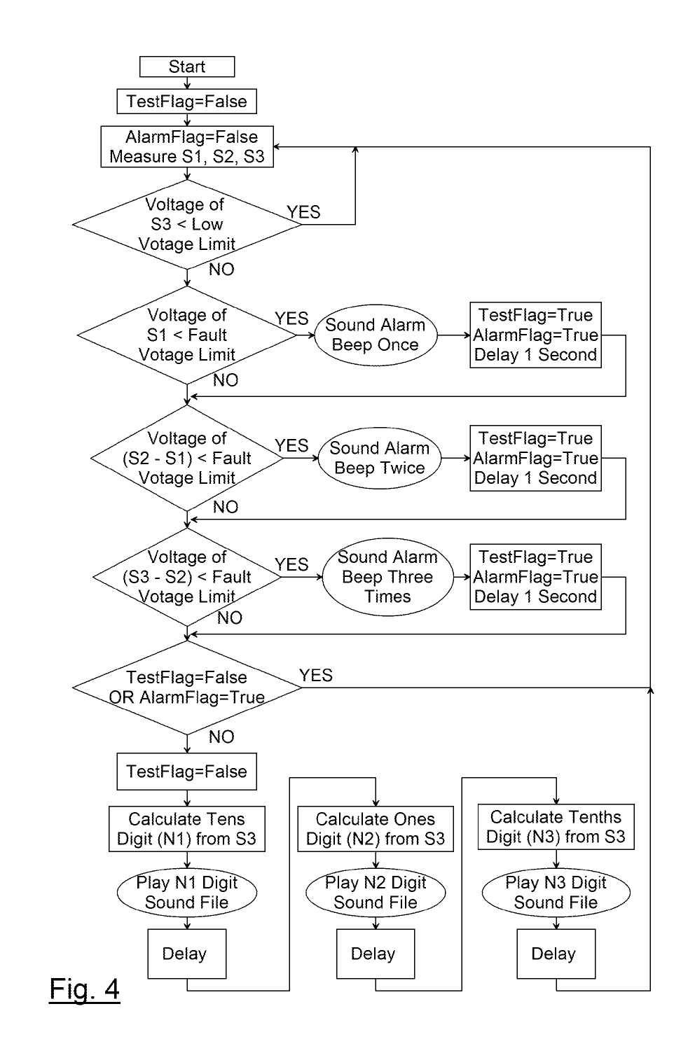

As shown in FIG. 3, the second embodiment of the invention is similar to the first embodiment of FIG. 1, with the exception that the microcontroller 12 outputs to a loud speaker 30. Likewise, as shown in FIG. 4, the firmware of the second embodiment functions similarly to the firmware of the first embodiment, with the exception of audibly playing the N₁ Digit Sound File, the N₂ Digit Sound File and the N₃ Digit Sound File to audibly convey the voltage S₃ via the loud speaker 30.

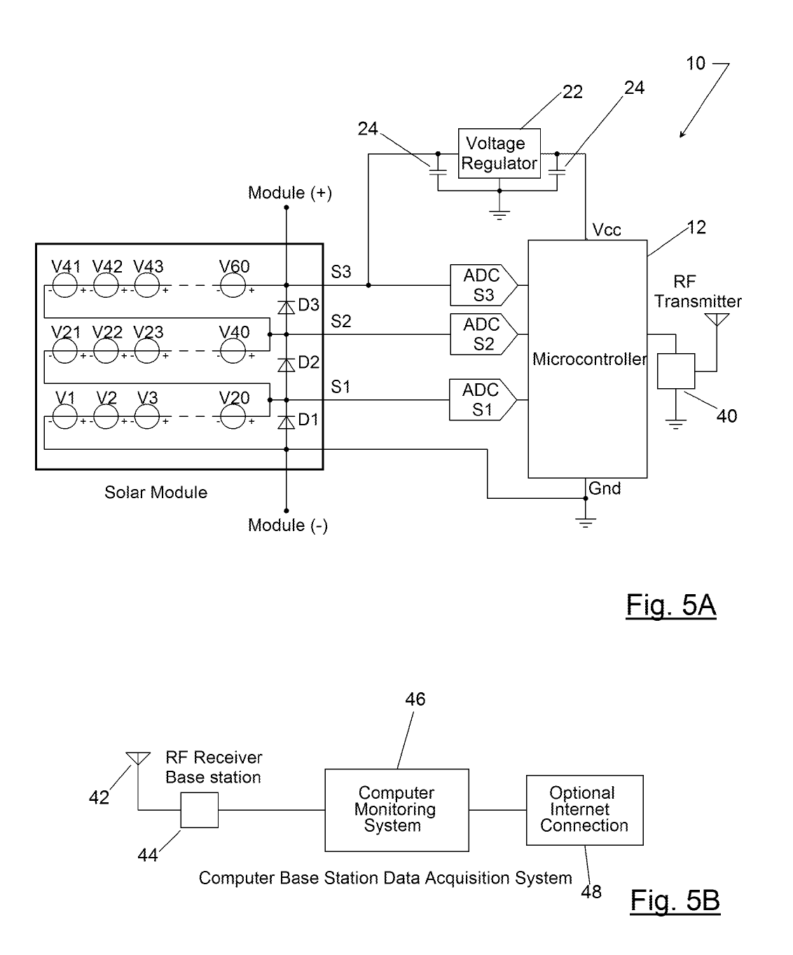

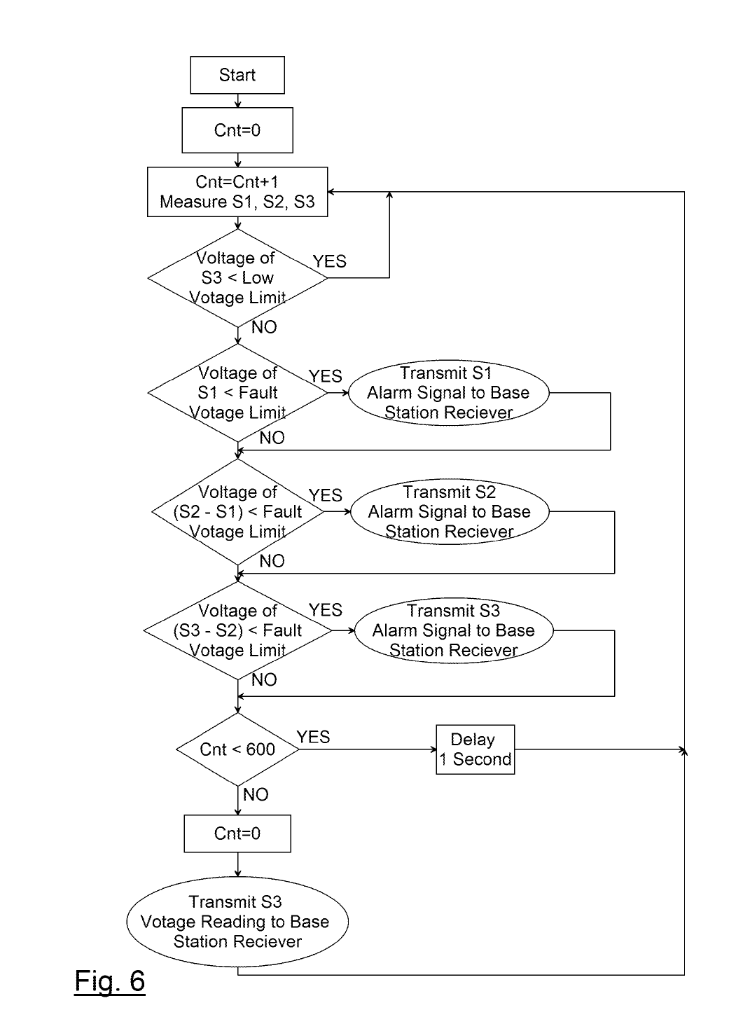

As shown in FIG. 5A, the third embodiment of the invention is similar to the second and third embodiments as previously described with the exception of the microcontroller 12 outputting to a radio frequency (RF) transmitter 40. A shown in FIG. 5B, the transmission of transmitter 40 is received at a Computer Base Station via its antenna 42. The received transmission of transmitter 40 is then recovered via a RF Receiver Base Station 44 and processed by a Computer Monitoring System 46. An Internet connection 48 may optionally be provided for remote monitoring via the web or the like. Likewise, as shown in FIG. 6, the firmware of the Microcontroller 12 in the third embodiment is similar to that of the first and second embodiments, with the exceptions that (1) the Alarm Signals S₁, S₂ and S₃ are transmitted to the computer Base Station and (2) the S₃ voltage reading is transmitted to the computer Base Station periodically (e.g. every 10 minutes.)

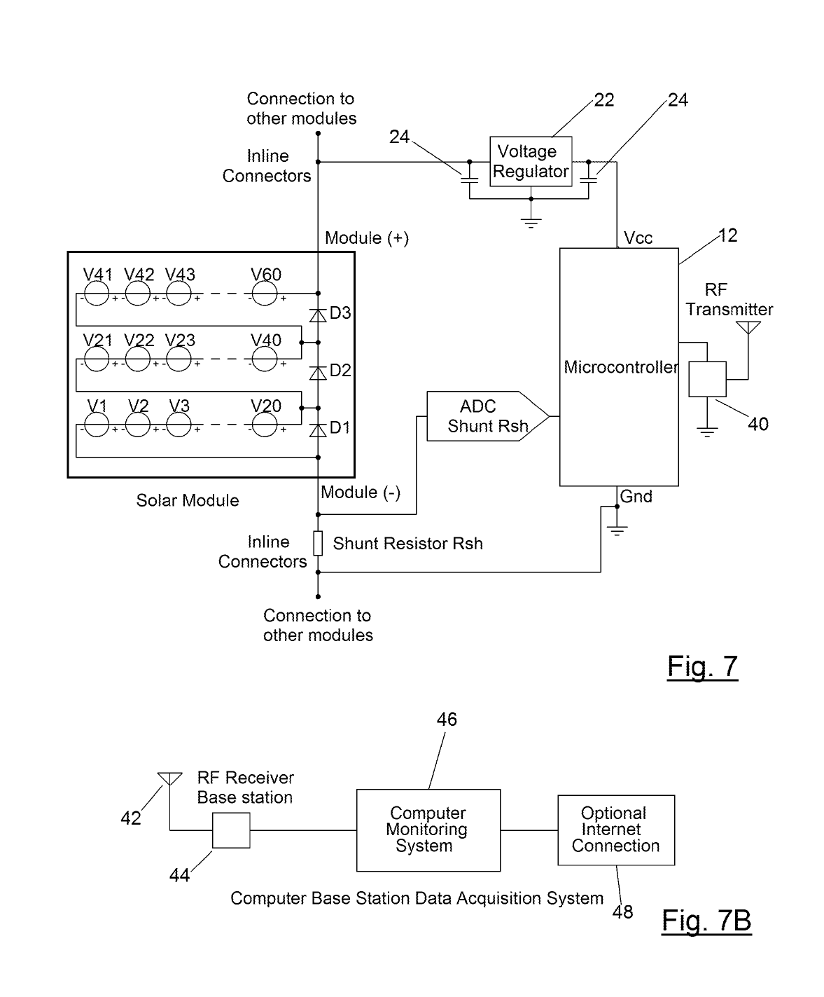

Referring now to FIG. 7A, the fourth embodiment of the invention comprises means for monitoring the current by incorporating a Shunt Resistor Rsh inline between adjacent solar modules and then measuring the voltage across the Shunt Resistor by a Shunt Resistor Analog to Digital Converter (ADC) connected to a microcontroller 12. The output of the Microcontroller 12 is supplied to the RF Transmitter 40 which then as described above, communicates with a computer Base Station (see FIG. 7B).

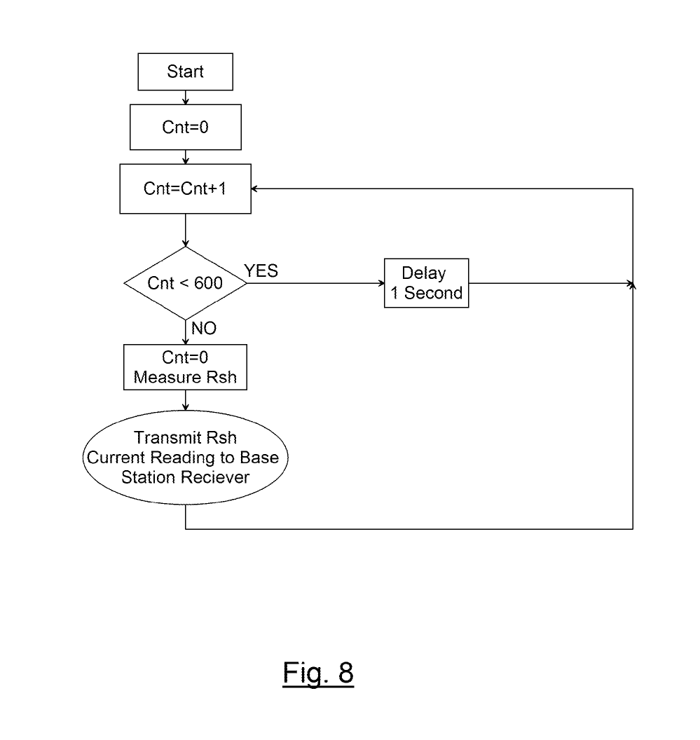

As shown in FIG. 8, the firmware in the Microcontroller 12 functions to transmit the current reading to the Base Station Receiver periodically (e.g., every 10 minutes.)

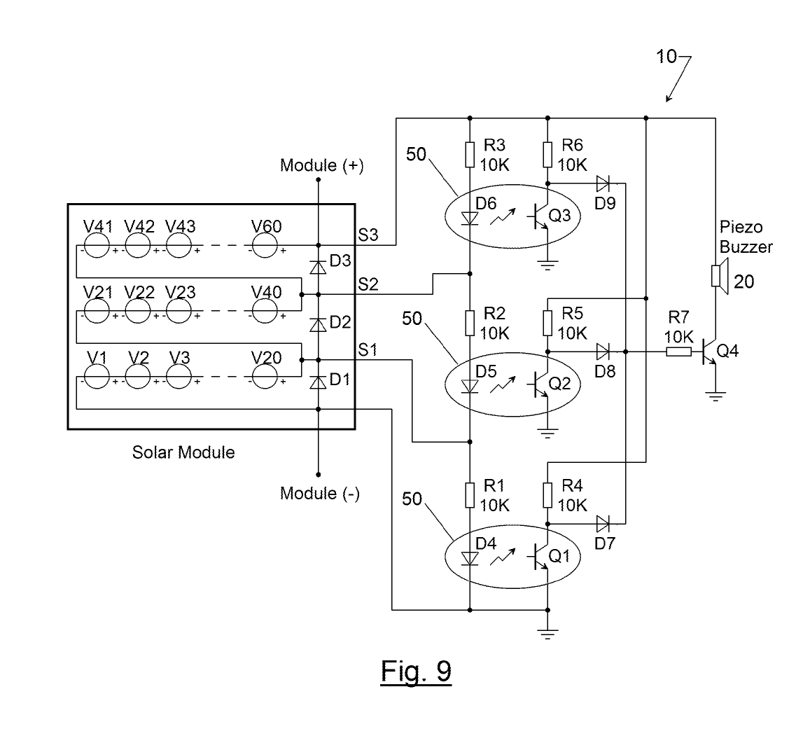

As shown in FIG. 9, the fifth embodiment of the invention comprises an ultra low cost version having an optocoupler 50 connected across the positive and negative terminals of each string S₁ₙ within the module. This connection is preferably made in the module's junction box along with the associated electronics. The output of the phototransistor Q₁₋₃ of each optocoupler 50 is connected in parallel through diodes D₇₋₉ to a common transistor Q₄ to drive it in pull-down mode. The collector of transistor Q₄ is connected to a piezoelectric buzzer 20. When the strings S₁₋₃ are working normally, the output of the phototransistors Q₁₋₃ are pulled low not allowing transistor Q₄ to conduct, thereby keeping the buzzer off. When a string S₁₋₃ malfunctions, the voltage begins to drop and when the voltage drops below a certain point, the bypass diode D₁₋₃ begins to conduct. As the voltage drops and goes negative −0.07 volts, the output of the resistivity of phototransistor Q ₁₋₃ goes high and allows the voltage on the base of transistor Q4 go high and conduct through the emitter. This allows the collector of Q4 to flow current thereby causing the piezobuzzer 20 to alarm.

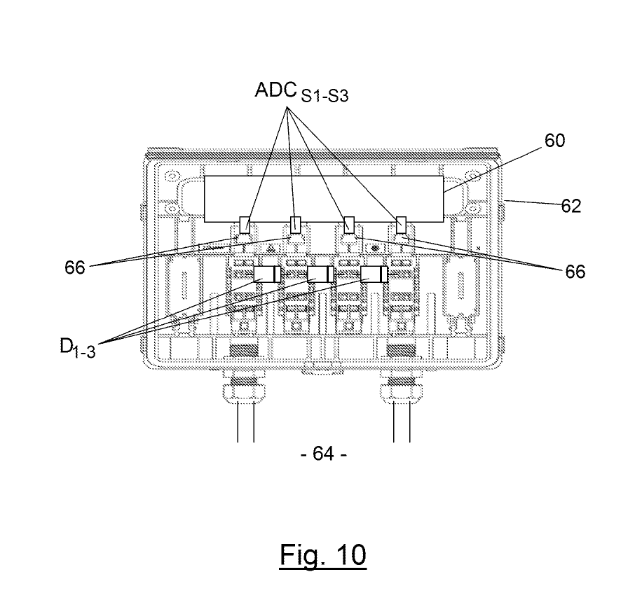

As shown in FIG. 10, the components of the Fault Detector 10 of the invention are preferably mounted onto a printed circuit board 60 having an elongated rectangular shape so as to be able to fit within a cavity inside a typical junction box 62 of a solar panel 64. In this manner, the electrical wires providing analog voltage to the ADCs₁-s₃ may be simply clipped-into the conventional wire connectors 66 typically used in such junction box 62.

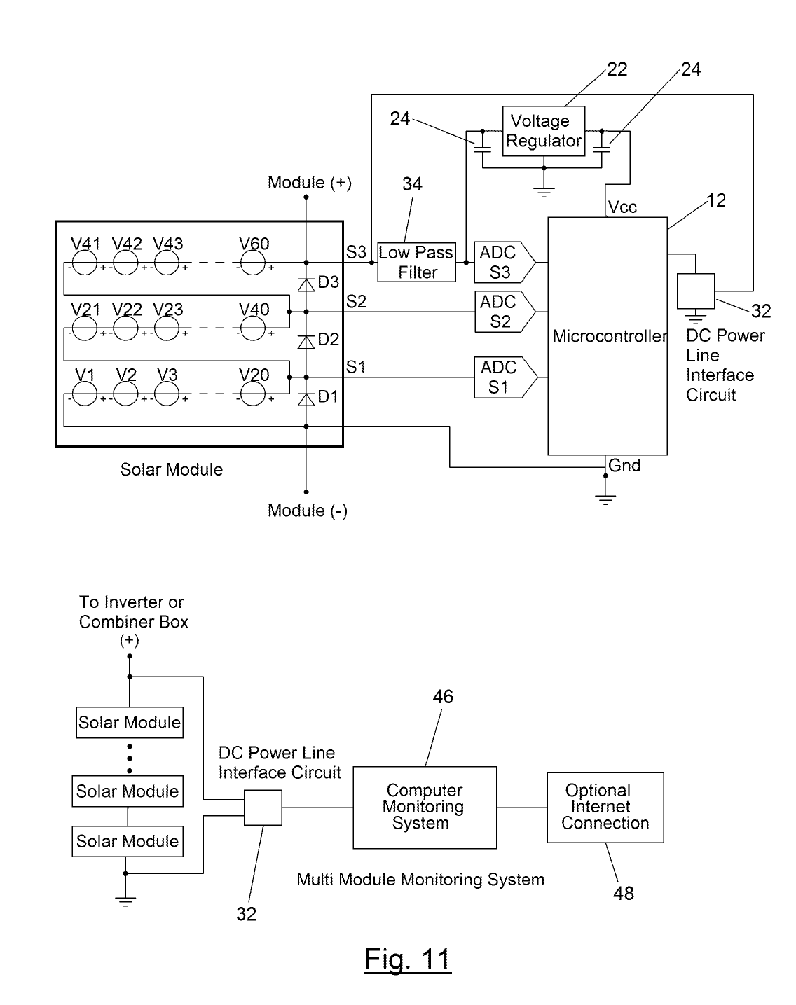

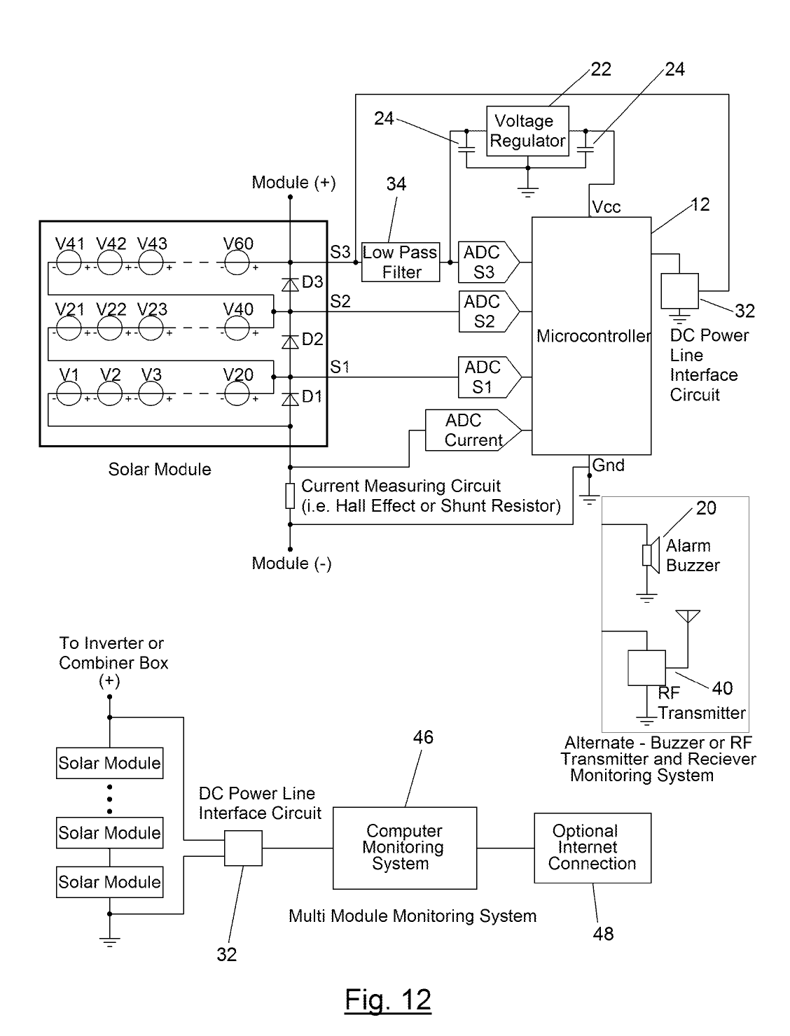

FIG. 11 shows a sixth embodiment of the invention in which the output of the microcontroller 12 is connected to a DC power line communication interface similar in concept to X10® and Insteon® that communicates the fault information outputted by the microcontroller 12 along existing wiring. However, this embodiment modulates the signal on the same DC wiring connecting the solar modules. A low pass filter 34 may be provided to isolate the DC power line communication from adversely affecting the operation of the ADCs₁-s₃. In a seventh embodiment shown in FIG. 12, the microcontroller 12 outputs to the DC power line communication interface 32 the amount of electrical current flowing between adjacent solar modules. As shown both FIGS. 11 and 12, the computer monitoring system 46 with its optional internet connection 48 allows for remote monitoring via a complementary DC communication interface circuit 32. Finally, it is noted that alternatively the computer monitoring system 46 may output to the alarms such as the alarm buzzer 20 (or loudspeaker 30) or to the RF transmitter 40 for further ease in monitoring.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A fault detector for a solar module having a plurality of strings of photovoltaic cells, comprising in combination:
a controller whose inputs comprise analog-to-digital converters;
a plurality of bypass diodes whose cathodes and anodes are connected in parallel across respective said strings of photovoltaic cells, said cathodes of respective bypass diodes being connected to said inputs of said controller; and
an alarm connected to an output of said controller.

2. The fault detector as set forth in claim 1, wherein said fault detector is located in a junction box of the solar module.

3. The fault detector as set forth in claim 1, wherein each respective said bypass diode becomes forward biased allowing current to pass around the respective string of defective or shaded cells, thereby reducing voltage losses through the solar module.

4. The fault detector as set forth in claim 1, wherein said controller outputs to the alarm to sound an audible alarm when the respective voltages of any one of the strings of photovoltaic cells falls below a threshold indicative of a fault condition.

5. The fault detector as set forth in claim 4, wherein said alarm comprises an alarm buzzer that indicates the specific string of photovoltaic cells whose voltage falls below said threshold indicative of a fault condition.

6. The fault detector as set forth in claim 5, wherein said alarm buzzer indicating the specific string of photovoltaic cells whose voltage falls below said threshold indicative of a fault condition comprises sounding a number of buzzes equal to the number of the specific string of photovoltaic cells whose voltage has fallen below said threshold indicative of a fault condition.

7. The fault detector as set forth in claim 4, wherein said alarm comprises a loud speaker.

8. The fault detector as set forth in claim 7, wherein said loud speaker audibly announces the specific string of photovoltaic cells whose voltage has fallen below said threshold indicative of a fault condition.

9. The fault detector as set forth in claim 1, wherein said alarm comprises a radio frequency (RF) transmitter.

10. The fault detector as set forth in claim 9, wherein said transmitter sends an RF signal to a base station indicating the voltages of the strings of photovoltaic cells.

11. The fault detector as set forth in claim 1, wherein said controller measures the electrical current flowing between each string of photovoltaic cells.

12. The fault detector as set forth in claim 1, wherein said alarm comprises a DC power line communication interface that insets fault information into DC wiring.

13. The fault detector as set forth in claim 12, further including a complementary DC power line communication interface to recover said fault information to a computer monitoring station.

14. A fault detector for a solar module having a plurality of strings of photovoltaic cells, comprising in combination:
an optocoupler connected across the positive and negative terminals of each of the strings of the photovoltaic cells; and
an alarm driven by said optocouplers.

15. A method for fault detection for a solar module having a plurality of strings of photovoltaic cells, comprising in the steps of:
connecting a plurality of bypass diodes with their respective cathodes and anodes connected in parallel across respective said strings of photovoltaic cells;
connecting said cathodes of respective bypass diodes to respective analog-to-digital converter inputs of a controller; and
outputting fault information to an alarm connected to an output of said controller.

16. The fault detector method as set forth in claim 15, wherein a fault detector implementing the method is located in a junction box of the solar module.

17. The fault detector method as set forth in claim 16, wherein each respective said bypass diode becomes forward biased allowing current to pass around the respective string of defective or shaded cells, thereby reducing voltage losses through the solar module.

18. The fault detector method as set forth in claim 17, wherein said controller outputs to the alarm to sound an audible alarm when the respective voltages of any one of the strings of photovoltaic cells falls below a threshold indicative of a fault condition.

19. The fault detector method as set forth in claim 18, wherein said alarm comprises an alarm buzzer that indicates the specific string of photovoltaic cells whose voltage falls below said threshold indicative of a fault condition.

20. The fault detector method as set forth in claim 19, wherein said alarm buzzer indicating the specific string of photovoltaic cells whose voltage falls below said threshold indicative of a fault condition comprises sounding a number of buzzes equal to the number of the specific string of photovoltaic cells whose voltage has fallen below said threshold indicative of a fault condition.

21. The fault detector method as set forth in claim 18, wherein said alarm comprises a loud speaker.

22. The fault detector method as set forth in claim 21, wherein said loud speaker audibly announces the specific string of photovoltaic cells whose voltage has fallen below said threshold indicative of a fault condition.

23. The fault detector method as set forth in claim 15, wherein said alarm comprises a radio frequency (RF) transmitter.

24. The fault detector method as set forth in claim 23, wherein said transmitter sends an RF signal to a base station indicating the voltages of the strings of photovoltaic cells.

25. The fault detector method as set forth in claim 15, wherein said controller measures the electrical current flowing between each string of photovoltaic cells.

26. The fault detector method as set forth in claim 15, wherein said alarm comprises a DC power line communication interface that inserts fault information into DC wiring.

27. The fault detector as set forth in claim 26, further including a complementary DC power line communication interface to recover said fault information to a computer monitoring station.

28. A method for fault detection for a solar module having a plurality of strings of photovoltaic cells, comprising in the steps of:
connecting an optocoupler across the positive and negative terminals of each of the strings of the photovoltaic cells; and
said optocouplers driving an alarm.
